(19) United States
(12) Patent Application Publication
(10) Pub. No.: US 2026/0058455 A1
(43) Pub. Date: Feb. 26, 2026

(54) BUSBAR BRIDGE AND ASSEMBLY

(71) Applicant: Our Next Energy, Inc., Novi, MI (US)

(72) Inventors: Shane Greenwood, Walled Lake, MI (US); Jared Pieknik, Westland, MI (US)

(73) Assignee: Our Next Energy, Inc., Novi, MI (US)

(21) Appl. No.: 19/304,980

(22) Filed: Aug. 20, 2025

Related U.S. Application Data
(60) Provisional application No. 63/686,582, filed on Aug. 23, 2024.

(51) Int. Cl. H02G 5/00; H01R 4/30; H01R 4/34; H01R 25/16

(52) U.S. Cl. CPC H02G 5/007; H01R 4/305; H01R 4/34; H01R 25/162

(57) ABSTRACT

A busbar bridge for electrically connecting a busbar to a terminal is formed from a single electrically conductive metal sheet to define a six-sided cage entrapping a nut to prevent rotation when torque is applied to the nut.

### CROSS-REFERENCE TO RELATED APPLICATIONS

This application claims priority to U.S. Provisional Application No. 63/686,582, filed Aug. 23, 2024, which is incorporated herein by reference in its entirety.

### FIELD OF THE DISCLOSURE

The present disclosure relates to high voltage busbar connections, and more particularly to busbar connections using robust bolted joints that facilitate repeated installation and removal operations to allow servicing.

### BACKGROUND OF THE DISCLOSURE

Known high voltage busbar connections in battery management systems modulus typically are achieved using plug (male) and socket (female) type electrical connectors or swage (self-clinching) nuts. A plug or socket type connector at the end(s) of a busbar can be difficult to align with its counterpart due to the length and rigidity of the busbar. Even split misalignment can reduce contact between connectors, increasing resistance and power loss. Additionally, plug and socket type electrical connections can become subject to wear and failure after repeated installations and removals. A difficulty with swage nuts is that they have a known tendency to spin and fall out, possibly causing an electrical disconnection or even a short circuit. Swage nuts also have an unfavorably low maximum torque limit.

A potential alternative to plug and socket connections, and swage nuts, is to use snap-in (cage) nuts. However, snap-in nuts have a relatively small bearing area for the clamp loads of an electrical joint and are expected to creep (spin and fall out) over time.

U.S. Pat. No. 10,879,659 describes a system for connecting a busbar 2 to a mating busbar 10 using fastener 3, dielectric overmold 1, and nut 4 (see especially FIG. 4). Dielectric overmold 1 includes ribs 9 disposed in interior surfaces of openings 11 to lock nut 4 against rotation, while allowing nut 4 to move axially along opening 11 (see especially FIG. 3). While this patent describes a way of inhibiting nut rotation, it does so in a different, less cost-effective manner. This patent does not teach or suggest a busbar bridge shaped to form a six-sided cage adapted to capture a nut.

This disclosure addresses one or more of the foregoing problems or disadvantages by providing a bolted busbar joint that is more robust than the conventional solutions, allowing higher torque and serviceability (i.e., repeated assembly and disassembly of the connection or joint), and which is easily and inexpensively manufacturable from low cost materials.

### SUMMARY OF THE DISCLOSURE

Described herein is a busbar bridge having a simple, one-piece design that can be easily and inexpensively manufactured while at the same time exhibiting improved robustness, serviceability and torque resistance. The busbar bridge includes an electrically conductive plate shaped to form a cage for receiving a nut and engaging sides of the nut to prevent rotation when torque is applied to the nut.

Also described is a busbar bridge and busbar assembly for connecting electrical terminals. The assembly includes the busbar bridge having a one-piece plate shaped to form a cage capturing a nut, and a busbar bolted to the busbar bridge.

### BRIEF DESCRIPTION OF THE DRAWINGS

FIG. 1 is a perspective view of a battery management system (BMS) having a component with busbars prior to being electrically connected to terminals of the BMS.

FIG. 2 is a perspective view after the busbars have been bolted to the BMS.

FIG. 3 is a perspective view of a busbar bridge in accordance with this disclosure.

FIG. 4 is a side view of the busbar bridge shown in FIG. 3.

FIG. 5 is a perspective view of another busbar bridge having a different shape than that of FIGS. 3 and 4.

FIG. 6 is a side view of a bolt having a flanged head used for bolting a busbar to a busbar bridge.

### DETAILED DESCRIPTION

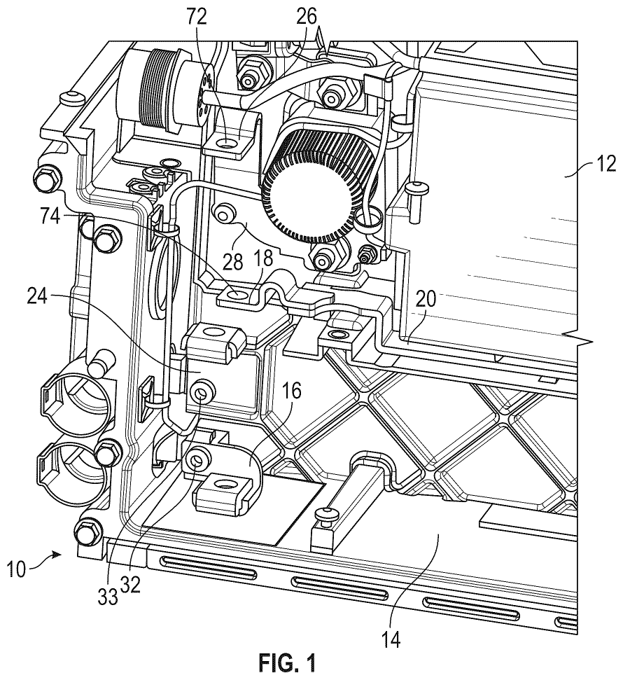

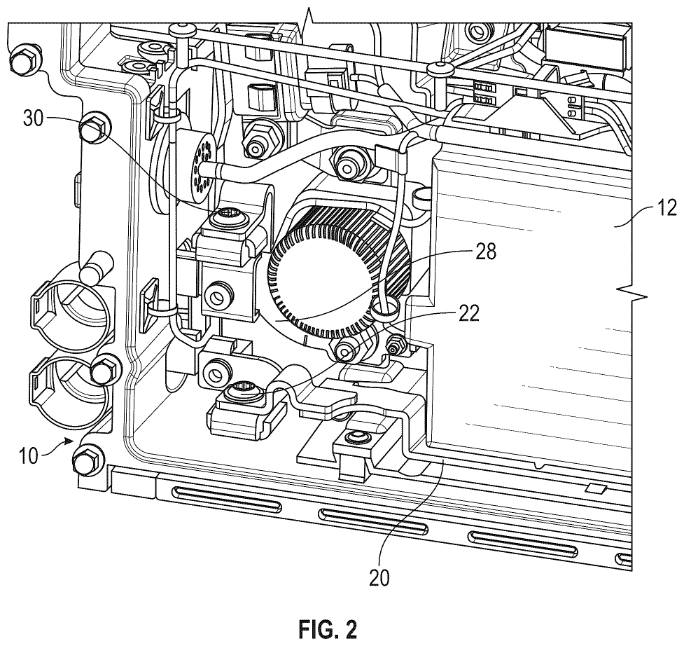

Shown in FIG. 1 is a battery management system (BMS) 10 prior to assembly of a component 12 onto a main frame 14 of the BMS. A first busbar bridge 16 is provided for electrically connecting an end 18 of busbar 20 to main frame 14 using a bolt 22 (FIG. 2). A second busbar bridge 24 is provided for electrically connecting an end 26 of busbar 28 with main frame 14 using a bolt 30. Busbar bridges 16 and 24 can be electrically connected to electrical terminals on main frame 14 using bolts 32, 33.

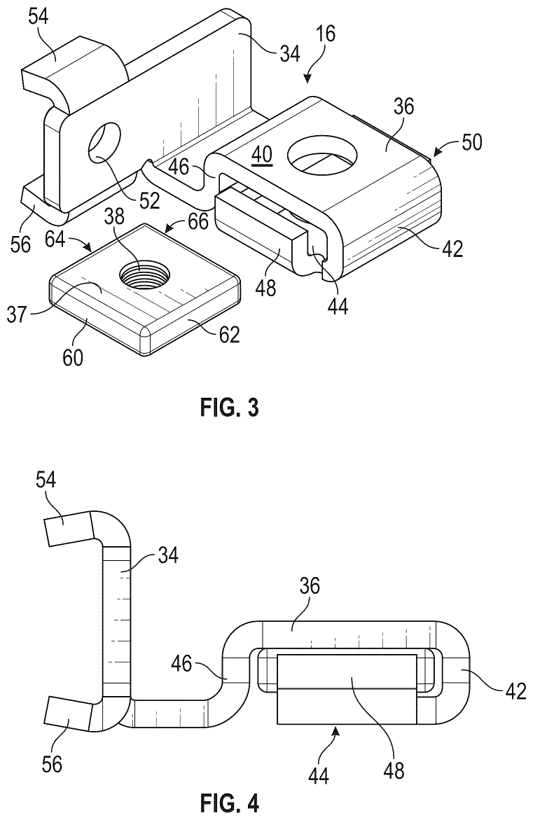

As shown in FIGS. 3 and 4, busbar bridges 16 and 24 in accordance with this disclosure comprise, consist of, or consist electrically of, an electrically conductive metal plate that is shaped (e.g., cut and bent) to have a mount section 34 and a six-sided cage section 36 for capturing a square nut 37 (a nut having a square profile as viewed along a line defining the axis of the threaded bore 38). The six-sides defining the cage for retaining nut 37 include an upper side 40, a front side 42, a bottom side 44, a back side 46, a left side 48, and a right side 50 (opposite the left side). Mount section 34 can be provided with an opening 52 to allow passage of a bolt to facilitate attachment and electrical connection between busbar bridges 16 and 24 and a corresponding electrical terminal. Tabs 54, 56 can project from mount section 34 to facilitate mounting on a terminal and/or to inhibit rotation of mount section 34 with respect to a terminal, especially during installation. An opening 58 is provided to allow a bolt to pass through and engage threaded bore 38 on nut 37.

Busbar bridges 16 and 24 and busbars 20 and 28 are preferably formed from inexpensive highly conductive metals such as aluminum, steel, and most preferably copper. Nut 37 is preferably formed of a high strength, low cost material such as steel (e.g., high carbon steel or stainless steel). Nut 37 has a plurality of sides 60, 62, 64, 66, each of which is in close proximity to a corresponding side 48, 42, 46, 50 respectively, of cage 36.

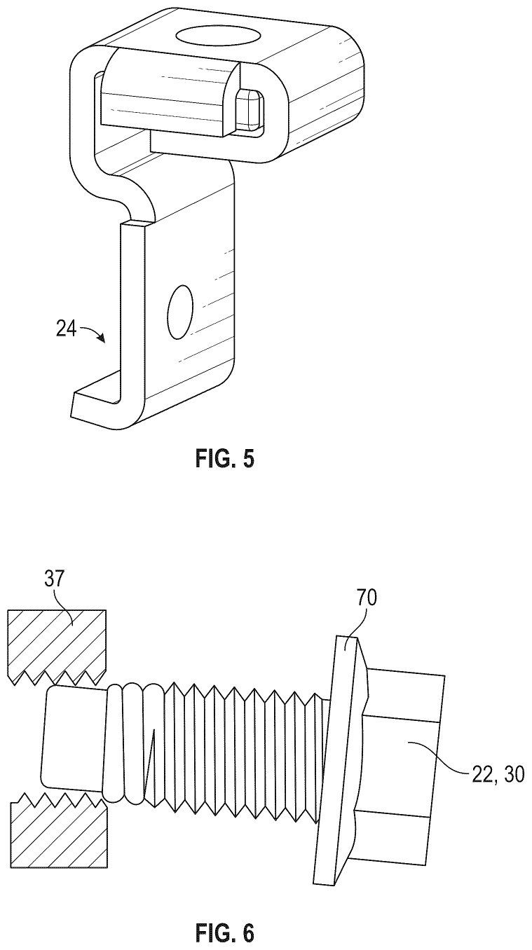

FIG. 5 shows busbar bridge 24 in detail. It has a slightly different shape than busbar bridge 16, but includes all of the features generally described with respect to busbar bridge 16.

FIG. 2 shows the BMS 10 in the assembled state with busbars 20 and 28 bolted to busbar bridges 16 and 24 respectively.

The disclosed busbar bridges eliminate the need for additional components and complexity, such as a separate overmold piece while providing a higher torque retention capacity. The disclosed busbar bridge also provide higher torque retention capacity than swage nuts. Testing has shown that the design can withstand more than 50 Nm of torque.

While nut 37 could be replaced with a octagonally (8-sided) shaped nut sized such that rotation in cage 36 is prevented, the square shape is preferred for its simplicity and larger reaction surfaces that better resist tightening torques. The larger surface area also distributes clamping force through the busbar over a larger area providing better electrical cross-section for electrical conduction.

As shown in FIG. 6, bolt 22, 30 can have a flanged head including flange section 70, eliminating need for a washer.

Cage 36 can be sized to prevent rotation of captured nut 37 while allowing a slight amount of movement (e.g., about 1 mm) along any of three mutually perpendicular axes to assist in alignment of bolt 22, 30 with nut 37. Allowing a small amount of movement, in combination with a screw having an alignment mechanism (e.g., self-correcting radiused threads) or anticross thread design. Such fasteners are, for example, sold under the “MAthread” trademark.

In order to better facilitate alignment of bolt opening 72, 74 at ends 26, 18 respectively of busbars 28, 20 respectively, busbars 20 and 28 can be provided with U-shaped flexing sections that can be easily bent without undesirable deformation of the busbar to accommodate a slight misalignment.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

1. A busbar bridge for electrically connecting a busbar to an electrical terminal, comprising:
an electrically conductive plate shaped to form a six-sided cage adapted to receive a nut; and
a nut disposed in the cage and having flat sides corresponding with and located in close proximity to the sides of the cage such that translational and rotational movement of the nut is prevented when torque is applied to a bolt engaging threads of the nut.

2. The busbar bridge of claim 1, wherein the nut is a square nut.

3. The busbar bridge of claim 1, that is formed of copper.

4. The busbar bridge of claim 1, wherein the nut is formed of steel.

5. The busbar bridge of claim 4, wherein the nut can withstand a torque of 50 Nm.

6. The busbar bridge of claim 1, wherein the cage is sized to allow about 1 mm of movement of the nut with respect to the cage along each of three mutually perpendicular axes.

7. A busbar bridge and busbar assembly for electrically connecting a first electrical terminal with a second electrical terminal, comprising:
the busbar bridge of claim 1;
a busbar having a first bolt aperture at a first end for connecting with the first electrical terminal and a second bolt aperture at a second end; and
a bolt connecting the second end of the busbar with the busbar bridge.

8. The assembly of claim 7, wherein the nut is a square nut.

9. The assembly of claim 7, that is formed of copper.

10. The assembly of claim 7, wherein the nut is formed of steel.

11. The assembly of claim 7, wherein the nut can withstand a torque of 50 Nm.

12. The assembly of claim 7, wherein the cage is sized to allow about 1 mm of movement of the nut with respect to the cage along each of three mutually perpendicular axes.

13. The assembly of claim 7, wherein the bolt has a flanged head.

14. The assembly of claim 7, wherein the bolt has self-connecting radiused threads.

15. The assembly of claim 7, wherein the busbar has a U-shaped flexing section.
